(19) United States
(12) Patent Application Publication
(10) Pub. No.: US 2026/0291388 A1
(43) Pub. Date: Sep. 24, 2026

(54) SWITCHING CONVERTER INCLUDING A SECONDARY BOOTSTRAP CAPACITOR

(71) Applicant: TEXAS INSTRUMENTS INCORPORATED, Dallas, TX (US)

(72) Inventors: Dinesh Kunte, Dallas, TX (US); Neeraj Keskar, Allen, TX (US)

(21) Appl. No.: 19/086,499

(22) Filed: Mar. 21, 2025

(51) Int. Cl. H02M 3/158; H02M 1/08; H02M 3/07

(52) U.S. Cl. CPC H02M 3/158; H02M 1/08; H02M 3/07

(57) ABSTRACT

An apparatus includes a first transistor having a first transistor terminal and a second transistor terminal. A second transistor has a third transistor terminal coupled to the second transistor terminal and has a fourth transistor terminal. A third transistor has a control terminal and a fifth transistor terminal. A driver has a driver output coupled to the control terminal and has a first driver terminal and a second driver terminal. The first driver terminal is coupled to the fourth terminal. A capacitor has a first capacitor terminal coupled to the first driver terminal and has a second capacitor terminal coupled to the second driver terminal and to the fifth transistor terminal.

### BACKGROUND

Some switching converters have a high side (HS) transistor coupled to a low side (LS) transistor. Such switching converters have a parasitic inductance between the HS and LS transistors due to the trace coupling the HS transistor to the LS transistor. During each switching cycle of the switching converters, the HS transistor turns on and off. As the HS transistor turns on, the sudden increase in current through the HS transistor causes a voltage to develop across the parasitic inductance in series with the source of HS transistor. Similarly, as the HS transistor turns off, the sudden decrease in current causes a voltage of opposite polarity to develop across the parasitic inductance in series with the source of HS transistor. The voltage across the parasitic inductance can slow down the switching speed of the HS transistor and/or damage the driver which controls the HS transistor

### SUMMARY

In one example, an apparatus includes a first transistor having a first transistor terminal and a second transistor terminal. A second transistor has a third transistor terminal coupled to the second transistor terminal and has a fourth transistor terminal. A third transistor has a control terminal and a fifth transistor terminal. A driver has a driver output coupled to the control terminal and has a first driver terminal and a second driver terminal. The first driver terminal is coupled to the fourth terminal. A capacitor has a first capacitor terminal coupled to the first driver terminal and has a second capacitor terminal coupled to the second driver terminal and to the fifth transistor terminal.

In another example, a power converter includes a first transistor having a first control terminal, a first transistor terminal, and a second transistor. The first transistor terminal is coupled to a first voltage terminal. A first driver has a first driver output, a first driver terminal, and a second driver terminal. The first driver output is coupled to the first control terminal. A second transistor has a second control terminal, a third transistor terminal, and a fourth transistor terminal. The third transistor terminal is coupled to the second transistor terminal, and the fourth transistor terminal is coupled to a second voltage terminal. A second driver has a second driver output, a third driver terminal, and a fourth driver terminal. The second driver output is coupled to the second control terminal. A third transistor has a third control terminal, a fifth transistor terminal and a sixth transistor terminal. The sixth transistor terminal is coupled to the first driver terminal. A capacitor has a first capacitor terminal and a second capacitor terminal. The first capacitor is coupled to the first driver terminal and to the sixth transistor terminal. The second capacitor terminal is coupled to the second driver terminal, the second transistor terminal, and the third transistor terminal. A fourth transistor has a seventh transistor terminal coupled to the fifth transistor terminal.

In yet another example, an apparatus includes a first transistor having a first transistor terminal and a second transistor terminal. A second transistor has a first control terminal, a third transistor terminal, and a fourth transistor terminal. The third transistor terminal is coupled to the second transistor terminal. A third transistor has a second control terminal and a fifth transistor terminal. A driver has a driver output coupled to the second control terminal and has a first driver terminal and a second driver terminal. The first driver terminal is coupled to the fourth transistor terminal. A first capacitor has a first capacitor terminal and a second capacitor terminal, the first capacitor terminal is coupled to the first driver terminal and to the fourth transistor terminal, and the second capacitor terminal is coupled to the second driver terminal and to the fifth transistor terminal. A second capacitor has a third capacitor terminal and a fourth capacitor terminal. The third capacitor terminal is coupled to the second and third transistor terminals, and the fourth capacitor terminal is coupled to the fifth transistor terminal. A control circuit has a control input and a control output, the control output coupled to the first switch control terminal, the control circuit configured to: turn off the second transistor upon the driver turning on the third transistor to allow current from the first capacitor to flow to the first driver terminal, and then turn on the second transistor while the third transistor is still on to thereby allow current from the second capacitor to flow through the second transistor to the first driver terminal.

### BRIEF DESCRIPTION OF THE DRAWINGS

FIG. 1 is a schematic diagram of a switching converter, in an example.

FIG. 2 is a schematic diagram of a switching converter including a control circuit, in another example.

FIG. 3 is a schematic diagram of the control circuit of FIG. 2, in an example.

FIG. 4 is a schematic diagram of the control circuit of FIG. 2, in another example.

FIG. 5 are waveforms illustrating the technical advantage of the switching converter of FIG. 2 as compared to the switching converter of FIG. 1.

### DETAILED DESCRIPTION

The same reference numbers or other reference designators are used in the drawings to designate the same or similar (either by function and/or structure) features.

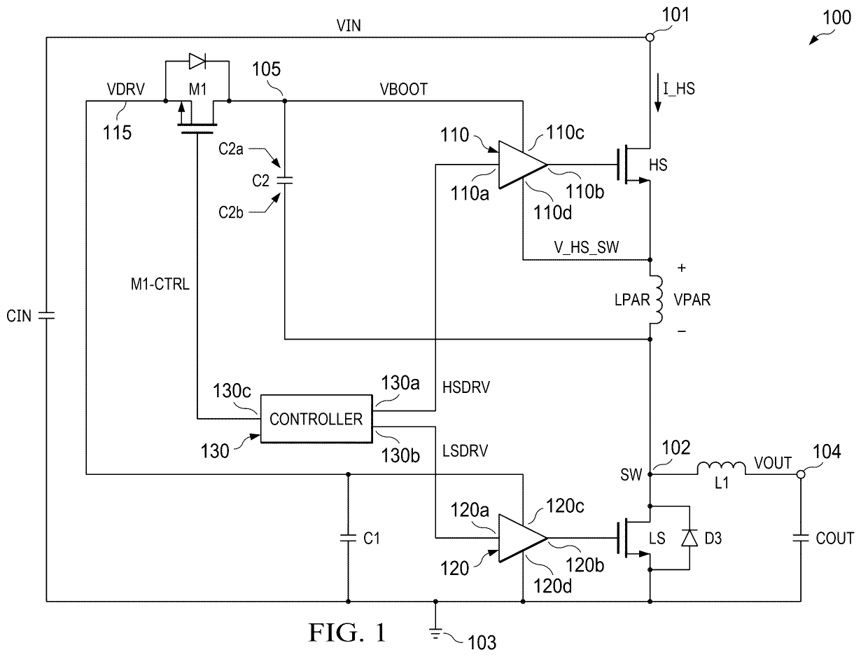

FIG. 1 is a schematic diagram of an example switching converter 100. Switching converter 100 includes HS and LS transistors, capacitors COUT, CIN, C1, and C2, transistor M1, drivers 110 and 120, and a controller 130. The HS transistor is coupled to the LS transistor at a switch terminal 102. In this example, the HS and LS transistors are n-channel field effect transistors (NFETs). The source of the HS transistor is coupled to the drain of the LS transistor. The drain of the HS transistor is coupled to an input voltage terminal 101 (VIN). The source of the LS transistor is coupled to a ground terminal 103. A parasitic inductance LPAR is between the source of the HS transistor and the switch terminal 102. The voltage at the source of the HS transistor is V_HS_SW. Parasitic inductance LPAR represents the parasitic inductance of a trace between the source of the HS transistor and the drain of the LS transistor. Inductor L1 has one terminal coupled to the switch terminal 102 and another terminal coupled to an output voltage terminal 104 (VOUT). Capacitor COUT is coupled between the output voltage terminal 104 and the ground terminal 103. Capacitor CIN is coupled between the input voltage terminal 101 and the ground terminal 103.

Driver 110 has an input 110a, an output 110b, and driver terminals 110c and 110d. Driver 120 has an input 120a, an output 120b, and driver terminals 120c and 120d. The output 110b of driver 110 is coupled to the gate of the HS transistor. The output 120b of driver 120 is coupled to the gate of the LS transistor. Controller 130 has outputs 130a, 130b, and 130c. Controller 130 generates control signals HSDRV and LSDRV at respective outputs 130a and 130b. The output 130a of controller 130 is coupled to the input 110a of driver 110, and the output 130b is coupled to the input 120a of driver 120.

Transistor M1 is an NFET whose gate is coupled to output 130c of controller 130. The drain of transistor M1 is coupled to driver terminal 110c of driver 110 at a boot terminal 105. The voltage at the boot terminal 105 is VBOOT. One terminal of capacitor C2 is coupled to the boot terminal 105 and, accordingly, to driver terminal 110c of driver 110. The other terminal of capacitor C2 is coupled to the switch terminal 102 and to driver terminal 110d. The source of transistor M1 is coupled to one terminal of capacitor C1 and to driver terminal 120c of driver 120. The other terminal of capacitor C1 is coupled to driver terminal 120d of driver 120 and to the ground terminal 103. Voltage rail 115 provides a voltage VDRV (e.g., from an externally-supplied voltage source or internal voltage source) to the driver terminal 120c of driver 120 and to the source of transistor M1.

In one example, some of the components shown in FIG. 1 are fabricated on the same integrated circuit (IC) and other components are external to that IC. In one example, the HS and LS transistors, drivers 110 and 120, transistor M1, and controller 130 are fabricated on the IC. Inductor L1 and capacitors C1, C2, CIN, and COUT may be external to the IC and coupled to the IC via, for example, traces on a printed circuit board. In other examples, a different combination of components of FIG. 1 are on the IC. The IC may have externally-accessible terminals coupled to the input voltage terminal 101, switch terminal 102, ground terminal 103, boot terminal 105, and voltage rail 115.

Capacitor C2 is also referred to as a bootstrap capacitor. The terminals of capacitor C2 are coupled between driver terminals 110c and 110d of driver 110. In an example in which the IC provides an externally-accessible switch terminal 102 and an externally-accessible boot terminal 105, capacitor C2 is coupled between the switch terminal 102 and the boot terminal 105. The charge on capacitor C2 is used to provide power to driver 110 to thereby turn on the HS transistor.

At the beginning of each switching cycle, controller 130 asserts control signals HSDRV to driver 110 and LSDRV to driver 120 at appropriate polarity levels to turn on the HS transistor and turn off the LS transistor. Controller 130 also asserts a control signal M1_CTRL at output 130c to the gate of transistor M1 to thereby turn off transistor M1. To turn on the HS transistor, the charge on capacitor C2 is used to power driver 110. The charge on capacitor C2 is at least partially dissipated while turning on the HS transistor.

During another portion of the switching cycle, controller 130 asserts control signals HSDRV, LSDRV, and M1_CTRL at appropriate polarities to turn off the HS transistor and turn on the LS transistor and transistor M1. With transistor M1 on, current from voltage rail 115 flows through transistor M1 to charge capacitor C2, which was previously partially discharged to turn on the HS transistor.

The current through the HS transistor is current I_HS. When the HS transistor initially turns, current I_HS ramps up quickly thereby resulting in a large change of current with respect to time (high di/dt). The current I_HS may be even higher than the load current through inductor L1 due to the reverse recovery of the body diode D3 of the LS transistor. The high di/dt of current I_HS causes a voltage drop VPAR across parasitic inductance LPAR. The polarity is such that the source of HS transistor is more positive than the switch terminal 102. Ideally, the voltage across capacitor C2 is applied to terminals 110c and 110d of driver 110 to turn on the HS transistor. For example, if capacitor C2 is charged to 5V, then when controller 130 asserts control signal HSDRV to turn on the HS transistor, driver 110 is powered by 5V between its terminals 110 c and 110 d. However, because one terminal of capacitor C2 is coupled to the switch terminal 102, the voltage drop across the parasitic inductance LPAR as current I_HS ramps up causes a smaller voltage to be applied across driver terminals 110c and 110d of driver 110. The smaller driver voltage resulting from the voltage drop across the parasitic inductance LPAR results in a slower switching speed for turning on the HS transistor. The slower HS transistor switching speed results in a high switching loss.

When the HS transistor initially turns off, current I_HS ramps down very quickly thereby resulting in a negative voltage VPAR across the parasitic inductance LPAR. A negative voltage VPAR means that the voltage at driver terminal 110d is less than the voltage at the switch terminal 102. As a result of a negative voltage VPAR when the HS transistor initially turns off, the voltage drop between driver terminals 110c and 110d is greater than the voltage across capacitor C2. For example, if capacitor C2 is charged to 5V, the voltage provided to driver 110 will be greater than 5V. The increased voltage between terminals 110 c and 110 d may exceed the safe operating area (SOA) of at least some of the transistors with driver 110. For example, the rated maximum drain-to-source voltage of transistors within driver 110 may be exceeded. Exceeding the SOA of transistors within driver 110 may damage such transistors and cause driver 110 to fail.

One possible solution to the problems described above is for the IC to include an additional externally-accessible terminal that is coupled directly to the source of the HS transistor (terminal 110d). The terminal C2b can directly couple to terminal 110d thereby removing the impact of the LPAR on the HS driver 110. Then the voltage VPAR will not impact voltage across the terminals 110c and 110d. Such a solution, however, would require an additional externally-accessible terminal which would undesirably make the IC package larger.

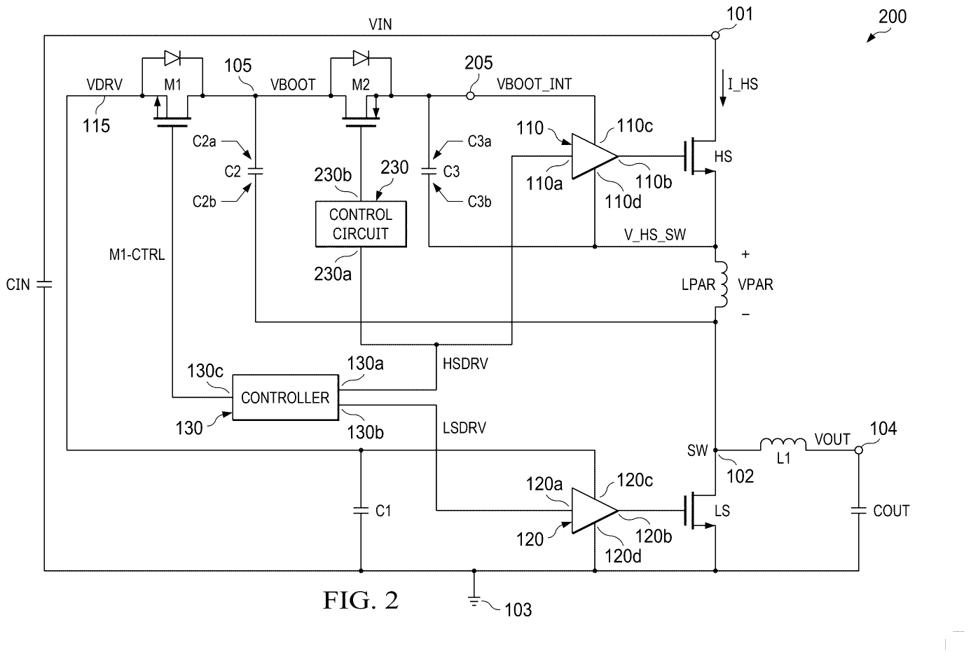

FIG. 2 is a schematic diagram of a switching converter 200 in another example. Switching converter 200 in FIG. 2 is similar to switching converter 100 in FIG. 1, but switching converter 200 includes a transistor M2, a capacitor C3, and a control circuit 230 not present in switching converter 100. Like switching converter 100, switching converter 200 includes the HS and LS transistors, capacitors COUT, CIN, C1, and C2, transistor M1, drivers 110 and 120, and a controller 130.

In one example, some of the components shown in FIG. 2 are fabricated on the same IC and other components are external to that IC. For example, the HS and LS transistors, drivers 110 and 120, capacitor C3, transistors M1 and M2, control circuit 230, and controller 130 may be fabricated on the IC. Inductor L1 and capacitors C1, C2, CIN, and COUT may be external to the IC and coupled to the IC via, for example, traces on a printed circuit board on which the IC is mounted. In other examples, a different combination of components of FIG. 2 are on the IC. The IC may have externally-accessible terminals coupled to the input voltage terminal 101, switch terminal 102, ground terminal 103, boot terminal 105, and voltage rail 115.

The source of the HS transistor is coupled to the drain of the LS transistor. The drain of the HS transistor is coupled to the input voltage terminal 101. The source of the LS transistor is coupled to the ground terminal 103. Inductor L1 has one terminal coupled to the switch terminal 102 and another terminal coupled to an output voltage terminal 104. Capacitor COUT is coupled between the output voltage terminal 104 and the ground terminal 103. Capacitor CIN is coupled between the input voltage terminal 101 and the ground terminal 103. As described above, the output 110b of driver 110 is coupled to the gate of the HS transistor, and the output 120b of driver 120 is coupled to the gate of the LS transistor. The output 130a of controller 130 is coupled to the input 110a of driver 110, and the output 130b is coupled to the input 120a of driver 120.

Transistor M2 is a p-channel field effect transistor (PFET). The drain of transistor M2 is coupled to the drain of transistor M1 at the boot terminal 105. The source of transistor M2 is coupled to the driver terminal 110c of driver 110 and to a terminal C3a of capacitor C3 at a VBOOT_INT terminal 205. The other terminal C3b of capacitor C3 is coupled to driver terminal 110d and to the source of the HS transistor, rather than, as is the case for capacitor C2, to the switch terminal 102. In other words, terminal C3a is coupled to driver terminal 110d while bypassing parasitic inductance LPAR. Because capacitor C3 is fabricated on the same IC as driver 110 and the HS transistor, terminal C3b can be connected to driver terminal 110d through a shorter trace that does not include the parasitic inductance LPAR. Control circuit 230 has an input 230a and an output 203b. The input 230a is coupled to the output 130a of controller 130 and receives the control signal HSDRV. The output 230b of control circuit 230 is coupled to the gate of transistor M2.

The gate of transistor M1 is coupled to output 130c of controller 130. The drain of transistor M1 is coupled to one terminal of capacitor C2 and to the drain of transistor M2, rather than, as in the example of FIG. 1, to driver terminal 110c. Accordingly, the boot terminal 105 is not coupled to the driver terminal 110c of driver 110 and instead is coupled to the drain of transistor M2. The other terminal of capacitor C2 is coupled to the switch terminal 102 and to driver terminal 110d. The source of transistor M1 is coupled to one terminal of capacitor C1 and to driver terminal 120c of driver 120. The other terminal of capacitor C1 is coupled to driver terminal 120d of driver 120 and to the ground terminal 103.

In operation, control circuit 230 turns on and off transistor M2 based on control signal HSDRV. When controller 130 asserts control signal HSDRV to a logic level (e.g., logic high) to turn on the HS transistor, control circuit 230 responds to control signal HSDRV by turning off transistor M2 for a short time (e.g., less than the period of a switching cycle). With transistor M2 off, the voltage at the boot terminal 105 is de-coupled from the VBOOT_INT terminal 205. Capacitor C3 is a secondary bootstrap capacitor by which the voltage across capacitor C3 is provided across driver terminals 110c and 110d to allow driver 110 to begin to turn on the HS transistor. As a result of transistor M2 being off, the voltage drop VPAR across parasitic inductance LPAR does not affect (e.g., does not reduce) the voltage applied across driver terminals 110c and 110d of driver 110.

In one example, control circuit 230 keeps transistor M2 off for a blanking period of time that is approximately equal to the time during which the ramp up of current I_HS causes the voltage drop VPAR across parasitic inductance LPAR. At the end of the blanking period of time, control circuit 230 turns on transistor M2 to allow the voltage across capacitor C2 to provide power to driver 110 and replenish the charge lost by capacitor C3 during the initial blanking time.

When controller 130 asserts control signals HSDRV and LSDRV to logic states to turn off the HS transistor and turn on the LS transistor (terminal 102 pulled to GND), controller 130 asserts control signal M1_CTRL to a logic state to turn on transistor M1 to charge capacitor C2. Further, control circuit 230 continues to keep transistor M2 on to charge capacitor C3.

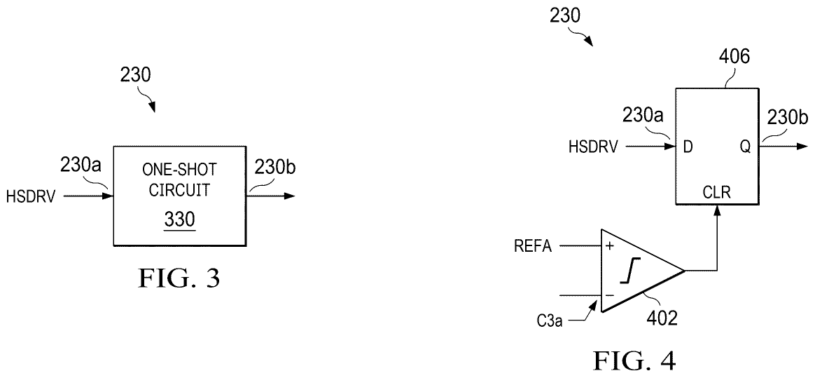

FIG. 3 is a schematic diagram of an example implementation of control circuit 230. In this example, control circuit 230 includes a one-shot circuit 330. One-shot circuit 330 generates a pulse at output 230b in response to, for example, a rising edge of control signal HSDRV. The width of the pulse generated by one-shot circuit 330 is approximately equal to the blanking period. Accordingly, one-shot circuit 330 generates a pulse to turn off transistor M2 for a time duration equal to the width of the pulse (e.g., approximately equal to the blanking period). At the end of the time delay implemented by the pulse generated by one-shot circuit 330, the signal at output 230b becomes a logic level (e.g., logic low) to thereby turn on transistor M2 to allow capacitor C2 to continue to power driver 110.

FIG. 4 is a schematic diagram of another example implementation of control circuit 230. In this example, control circuit 230 includes a comparator 402 and a latch 406. Comparator 402 has positive (+) and negative (−) inputs and an output. The positive input receives a reference voltage REFA with respect to terminal 110d, and the negative input is coupled to capacitor terminal C3a of capacitor C3. Accordingly, control circuit 230 includes input 230a and output 230b, as described above, and also couples to capacitor C3. Latch 406 has a data (D) input, a clear (CLR) input, and a Q output. The control signal HSDRV is provided to the D input. The output of comparator 402 is coupled to the CLR input. The Q output of latch 406 represents the output 230b of control circuit 230. When the voltage across capacitor C3 falls below REFA, the output of comparator 402 becomes logic high thereby clearing latch 406 and turning on transistor M2 to recharge capacitor C3.

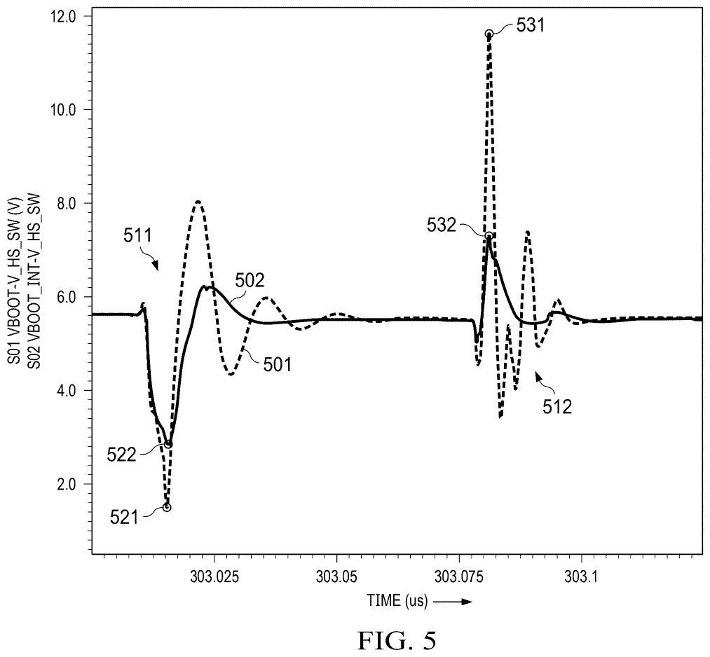

FIG. 5 are waveforms 501 and 502 representing the voltage difference between the voltage at the boot terminal 105 (VBOOT) and the voltage at the source of the HS transistor (V_HS_SW), in other words, the voltage difference between driver terminals 110c and 110d of driver 110. Waveform 501 represents the voltage difference VBOOT—V_HS_SW for the switching converter 100 of FIG. 1. Waveform 502 represents the voltage difference VBOOT_INT—V_HS_SW for the switching converter 100 of FIG. 2. The waveforms illustrate an example of the voltage difference across the driver 110when the HS transistor turns on (511). For waveform 501 (switching converter 100 of FIG. 1), the voltage difference VBOOT—V_HS_SW drops to a minimum of approximately 1.4V as identified by reference numeral 521. However, for waveform 502 (switching converter 200 of FIG. 2), the lowest voltage difference VBOOT_INT—V_HS_SW is at approximately 2.9V, which advantageously is 1.5V higher than for the switching converter 100. As a result, driver 110 for switching converter 200 can turn on the HS transistor faster and with lower switching losses.

The waveforms also illustrate an example of the voltage difference VBOOT—V_HS_SW when the HS transistor turns off (512). For waveform 501 (switching converter 100 of FIG. 1), the voltage difference VBOOT—V_HS_SW increases to a peak of approximately 11.6V as identified by reference numeral 531. However, for waveform 502 (switching converter 200 of FIG. 2), the peak voltage difference VBOOT_INT—V_HS_SW is at approximately 7.3V, which advantageously is 4.3V lower than for the switching converter 100. As a result, driver 110 for switching converter 200 has a lower peak operating voltage than for switching converter 100 and, accordingly, has a lower risk of being damaged.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component. The circuits (e.g., switching converters) described herein are apparatuses.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter. The gate, source, and drain of a FET and base, collector, and emitter of a BJT are terminals of the transistor.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. An apparatus, comprising:
a first transistor having a first transistor terminal and a second transistor terminal;
a second transistor having a third transistor terminal coupled to the second transistor terminal and having a fourth transistor terminal;
a third transistor having a control terminal and a fifth transistor terminal;
a driver having a driver output coupled to the control terminal and having a first driver terminal and a second driver terminal, the first driver terminal coupled to the fourth terminal; and
a capacitor having a first capacitor terminal coupled to the first driver terminal and having a second capacitor terminal coupled to the second driver terminal and to the fifth transistor terminal.

2. The apparatus of claim 1, wherein the capacitor is a first capacitor, and the apparatus further comprises:
a fourth transistor having a sixth transistor terminal coupled to the fifth transistor terminal and having a seventh transistor terminal coupled to a ground terminal; and
a second capacitor having a third capacitor terminal and a fourth capacitor terminal, the third capacitor terminal coupled to the second and third transistor terminals, and the fourth capacitor terminal coupled to the fifth transistor terminal.

3. The apparatus of claim 1, wherein the third transistor is a field effect transistor having a drain and a source, the third transistor terminal is the drain of the second transistor, and the fourth transistor terminal is the source of the second transistor.

4. The apparatus of claim 3, wherein the second transistor is a p-channel field effect transistor.

5. The apparatus of claim 3, wherein the driver has a driver input, the third transistor has a control terminal, and the apparatus further comprises a control circuit having a control input and a control output, the control input coupled to the driver input, and the control output coupled to the control terminal of the third transistor.

6. The apparatus of claim 5, wherein the control circuit includes a one-shot circuit having a one-shot input coupled to the control input and having a one-shot output coupled to the control output.

7. The apparatus of claim 5, wherein the control circuit is configured to respond to an edge of a control signal at the control input and at the driver input by generating a pulse at the control output.

8. The apparatus of claim 7, wherein the second transistor is configured to turn off during the pulse generated by the control circuit.

9. The apparatus of claim 5, wherein the control circuit includes a comparator having a first comparator input coupled to the first capacitor terminal and having a second comparator input configured to receive a reference voltage.

10. The apparatus of claim 9, wherein the control circuit is configured to:
respond to an edge of a control signal at the control input and at the driver input by turning off the second transistor; and
respond to a comparator signal from the comparator indicating that a voltage of the first capacitor terminal is below the reference voltage by turning on the second transistor.

11. A power converter, comprising:
a first transistor having a first control terminal, a first transistor terminal, and a second transistor, the first transistor terminal coupled to a first voltage terminal;
a first driver having a first driver output, a first driver terminal, and a second driver terminal, the first driver output coupled to the first control terminal;
a second transistor having a second control terminal, a third transistor terminal, and a fourth transistor terminal, the third transistor terminal coupled to the second transistor terminal, and the fourth transistor terminal coupled to a second voltage terminal;
a second driver having a second driver output, a third driver terminal, and a fourth driver terminal, the second driver output coupled to the second control terminal;
a third transistor having a third control terminal, a fifth transistor terminal and a sixth transistor terminal, the sixth transistor terminal coupled to the first driver terminal;
a capacitor having a first capacitor terminal and a second capacitor terminal, the first capacitor coupled to the first driver terminal and to the sixth transistor terminal, the second capacitor terminal coupled to the second driver terminal, the second transistor terminal, and the third transistor terminal; and
a fourth transistor having a seventh transistor terminal coupled to the fifth transistor terminal.

12. The power converter of claim 11, wherein the first, second, third, and fourth transistors are provided on an integrated circuit, and the integrated circuit has an externally-accessible terminal coupled to the fifth and seventh transistor terminals.

13. The power converter of claim 12, wherein the capacitor is a first capacitor, and the power converter comprises a second capacitor having a terminal coupled to the externally-accessible terminal.

14. The power converter of claim 11, further comprising a control circuit having a control input coupled to the first driver input and having a driver output coupled to the third control terminal, wherein, in response to a signal at the control input and the first driver input:
the first driver is configured to turn on the first transistor; and
the control circuit is configured to turn off the third transistor.

15. The power converter of claim 14, wherein the control circuit is configured to turn on the third transistor after a time delay and while the first transistor is still on.

16. The power converter of claim 11, wherein the third transistor is a p-channel field effect transistor (PFET), the fifth transistor terminal is a drain of the PFET, and the sixth transistor terminal is a source of the PFET.

17. An apparatus, comprising:
a first transistor having a first transistor terminal and a second transistor terminal;
a second transistor having a first control terminal, a third transistor terminal, and a fourth transistor terminal, the third transistor terminal coupled to the second transistor terminal;
a third transistor having a second control terminal and a fifth transistor terminal;
a driver having a driver output coupled to the second control terminal and having a first driver terminal and a second driver terminal, the first driver terminal coupled to the fourth transistor terminal;
a first capacitor having a first capacitor terminal and a second capacitor terminal, the first capacitor terminal coupled to the first driver terminal and to the fourth transistor terminal, and the second capacitor terminal coupled to the second driver terminal and to the fifth transistor terminal;
a second capacitor having a third capacitor terminal and a fourth capacitor terminal, the third capacitor terminal coupled to the second and third transistor terminals, and the fourth capacitor terminal coupled to the fifth transistor terminal; and
a control circuit having a control input and a control output, the control output coupled to the first control terminal, the control circuit configured to:
turn off the second transistor upon the driver turning on the third transistor to allow current from the first capacitor to flow to the first driver terminal, and
then turn on the second transistor while the third transistor is still on to thereby allow current from the second capacitor to flow through the second transistor to the first driver terminal.

18. The apparatus of claim 17, wherein the control circuit is configured to turn off the second transistor for a predetermined delay period of time.

19. The apparatus of claim 17, wherein the second transistor is a p-channel field effect transistor having a source and a drain, the source being the fourth transistor terminal, and the drain being the third transistor terminal.

20. The apparatus of claim 17, wherein the apparatus is a switching converter.
